(19) United States
(12) Patent Application Publication
(10) Pub. No.: US 2026/0153735 A1
(43) Pub. Date: Jun. 4, 2026

(54) Method and optical system for expanding eyebox by overlapping computer generated hologram

(71) Applicant: Electronics and Telecommunications Research Institute, Daejeon (KR)

(72) Inventor: Jin Su LEE, Daejeon (KR)

(73) Assignee: Electronics and Telecommunications Research Institute, Daejeon (KR)

(21) Appl. No.: 19/357,637

(22) Filed: Oct. 14, 2025

(30) Foreign Application Priority Data
Oct. 14, 2024 (KR) 10-2024-0139482
Oct. 13, 2025 (KR) 10-2025-0147035

(51) Int. Cl. G02B 27/01

(52) U.S. Cl. CPC G02B 27/0103; G02B 2027/0109; G02B 2027/0116; G02B 2027/0123

(57) ABSTRACT

Disclosed are a method and an optical system for expanding an eyebox by overlapping CGHs. According to an embodiment of the disclosure, a method of expanding an eyebox may include: modulating an optical phase based on a phase value of CGH using a spatial light modulator, replicating the CGH based on the phase value using a 2D beam splitter to generate a plurality of CGHs, arranging or overlapping the plurality of CGHs without vacant spaces to generate a holographic image, and reconstructing the holographic image on the eyebox.

### CROSS-REFERENCE TO RELATED APPLICATIONS

The present application is based on, and claims priority from, Korean Patent Application Number 10-2024-0139482, filed Oct. 14, 2024, and Korean Patent Application Number 10-2025-0147035, filed Oct. 13, 2025, the disclosure of which is incorporated by reference herein in its entirety.

### TECHNICAL FIELD

The disclosure relates to a method and an optical system for expanding an eyebox by overlapping a computer generated hologram (CGH). More specifically, the disclosure relates to a method and an optical system for expanding an eyebox by replicating a CGH using a diffractive optical element and overlapping the replicated CGHs.

### BACKGROUND ART

The content described below merely provides background information related to the present embodiment and does not constitute the related art.

In recent years, a holographic display method has been gradually put into practical use as a display method of a three-dimensional image capable of providing full parallax and matching the depth perceived by the brain with the focal point of the eyes. The holographic display method utilizes the principle in which, when reference light is irradiated onto and diffracted by a hologram pattern recording an interference fringe obtained by interfering object light reflected from an original object with the reference light, an image of the original object is reproduced. Digital holographic display method is a method in which a computer-generated hologram (CGH) is provided to a spatial light modulator (SLM) as an electrical signal, and the spatial light modulator forms a hologram pattern according to the input CGH to modulate amplitude or phase delay, and diffract reference light, thereby generating a three-dimensional image.

The holographic display method is utilized in various fields such as medical care, education, or entertainment. In particular, the holographic display method can be used for a head-up display (HUD) of a vehicle. The head-up display of the vehicle displays various vehicle information, such as arrows guiding route changes in connection with navigation and text information indicating speed and the like, in the form of augmented reality on or beyond a windshield. An eye box is a region in which an image projected by the head-up display may be observed. If the position of a viewer's pupil deviates from the eyebox, the image becomes invisible to the viewer, and thus, the head-up display of the vehicle limits the observable region of the projected image within the eye box.

At this time, the eyebox has a close relationship with the field of view (FoV). The field of view refers to the maximum spatial range observable by a user through a display, and the eyebox refers to the positional region of the eyes in which the user can observe an image without distortion. To expand the field of view in an optical system, the distribution of diffracted light must be widely spread, which reduces the size of the eyebox under the same SLM conditions. Conversely, when the optical design is optimized to enlarge the eyebox, the diffraction angle decreases, thereby limiting the field of view. Accordingly, conventional holographic display systems have conflicting characteristics between expansion of the field of view and enlargement of the eyebox, which constitutes a major obstacle to the implementation of holographic displays. This relationship is defined by the following equation.

In a holographic display, the field of view is determined by the maximum diffraction angle that can be generated by a spatial light modulator. The maximum diffraction angle and the eyebox are determined by the following equation.

The maximum diffraction angle θₘₐₓ is calculated as θₘₐₓ=arcsin (λ/2p), where λ denotes the wavelength, and p denotes the pixel pitch of the spatial light modulator.

The eyebox (effective aperture) can be defined as D=Np, where N denotes the resolution, and p denotes the pixel pitch of the spatial light modulator.

That is, as the pixel pitch becomes smaller, a wider field of view can be obtained. However, this in turn causes a reduction in the effective aperture of the spatial light modulator, resulting in a smaller eyebox. That is, the size of the eyebox in the head-up display of the vehicle plays an important role in delivering image information to a user, but there is an inherent limitation in simultaneously expanding both the field of view and the eyebox. Accordingly, there is a need for research on a technology for enlarging the size of the eyebox while overcoming the mutually conflicting relationship between the field of view and the eyebox.

### DISCLOSURE OF INVENTION

### Technical Problem

The disclosure is directed to replicating a computer generated hologram (CGH) using a diffractive optical element and to arranging (tiling) or overlapping (superposing) the replicated CGHs without vacant spaces, and to reproducing a distortion-free hologram through the arrangement.

In addition, according to one embodiment, the disclosure is directed to selecting a reconstruction region within an effective aperture of a spatial light modulator for each of red (R), green (G), and blue (B) wavelengths in an eyebox arranged without vacant spaces, and to determining an optimized phase to be modulated by the spatial light modulator.

In addition, according to an embodiment, the disclosure is directed to determining an optimized phase to be modulated by comparing a reconstructed image, which is reproduced through an overlapped eyebox region, with an original image, and to determining the optimized phase within the overlapped region.

The problems to be solved by the disclosure are not limited to the problems mentioned above, and other problems not mentioned will be clearly understood by those skilled in the art from the following description.

### Solution to Problem

According to the disclosure, an optical system for expanding an eyebox may include: a hologram projection device configured to replicate a computer generated hologram (CGH) through a diffractive optical element, and to arrange or overlap a plurality of replicated CGHs without vacant spaces to generate a holographic image, and a wind shield unit configured to increase an optical path through multiple reflections and refractions and to form a hologram signal of the holographic image on an eyebox to deliver a reconstructed image to a user, wherein the hologram projection device may include: a spatial light modulator configured to modulate a phase of light based on a phase value of the CGH, and a 2D beam splitter configured to replicate the CGH based on the phase value to generate the plurality of CGHs, wherein the phase value may be a phase determined based on modulation characteristics of the spatial light modulator.

According to the disclosure, a method for expanding an eyebox may include: modulating a phase of light based on a phase value of CGH into a phase value using a spatial light modulator, replicating the CGH based on the phase value using a 2D beam splitter to generate a plurality of CGHs, arranging or overlapping the plurality of CGHs without vacant spaces to generate a holographic image, and forming a hologram signal of the holographic image on the eyebox to generate a reconstructed image, wherein the phase value may be a phase value determined based on modulation characteristics of the spatial light modulator.

According to the disclosure, a computer-readable recording medium having instructions stored thereon that, when executed by a computer, may cause the computer to perform the processes of: modulating a phase of light based on a phase value of a CGH into a phase value using a spatial light modulator, replicating the CGH based on the phase value using a 2D beam splitter to generate a plurality of CGHs, arranging or overlapping the plurality of CGHs without vacant spaces to generate a holographic image, and forming a hologram signal of the holographic image on an eyebox to generate a reconstructed image, wherein the phase value may be a phase value determined based on modulation characteristics of the spatial light modulator.

### Effects of Invention

According to the disclosure, it is possible to expand an eyebox and provide a uniform high-quality holographic image across an entire region of the eyebox.

In addition, according to an embodiment, it is possible to reduce the occurrence of double images, color separation, chromatic aberration, and the like at the boundary point of the eyebox.

In addition, according to an embodiment, it is possible to stably provide a holographic image within the eyebox region.

The effects that may be obtained in the disclosure are not limited to the effects mentioned above, and other effects not mentioned will be clearly understood by those of ordinary skill in the art from the following description.

### BRIEF DESCRIPTION OF DRAWINGS

FIG. 1 is an optical structural diagram for describing an optical system for expanding an eyebox in a holographic head-up display, according to an embodiment of the disclosure.

FIG. 2 is a diagram for describing a conventional method of expanding an eyebox and a perspective view of a holographic head-up display and a position of an eyebox and a method of expanding the eyebox according to an embodiment of the disclosure.

FIG. 3 is a flowchart for describing a process of determining an optimal phase to be modulated by a spatial light modulator in an expansion of an array-type eyebox or an overlapped eyebox without vacant spaces, according to an embodiment of the disclosure.

FIG. 4 is a diagram for describing an original image, a reconstructed image before optimizing phase, and a reconstructed image after optimizing phase in the overlapped eyebox, according to an embodiment of the disclosure.

FIG. 5 is a diagram for describing a method of specifying an effective region within a spatial light modulator for each wavelength according to a pupil position when an eyebox is expanded by arranging computer-generated holograms (CGHs) without vacant spaces, according to an embodiment of the disclosure.

### DETAILED DESCRIPTION FOR CARRYING OUT THE INVENTION

Hereinafter, some embodiments of the disclosure will be described in detail with reference to illustrative drawings. It should be noted that, in adding reference numerals to the components in each drawing, the same reference numerals are used for the same components as much as possible, even if they are shown in different drawings. In addition, in describing the disclosure, when it is determined that a specific description of a related known configuration or function may obscure the gist of the disclosure, a detailed description thereof will be omitted.

In describing the components of the embodiments according to the disclosure, reference numerals such as first, second, i), ii), a), and b) may be used. These numerals are merely used to distinguish one component from another component, and do not limit the nature, order, sequence, or the like of that components by such numerals. In the specification, when a part is described as “comprising” or “including” a certain component, it means that other components may be further included instead of excluding other components unless explicitly stated to the contrary.

The following detailed description, together with the accompanying drawings, is intended to describe exemplary embodiments of the present disclosure, and is not intended to represent the only embodiments in which the present disclosure may be practiced.

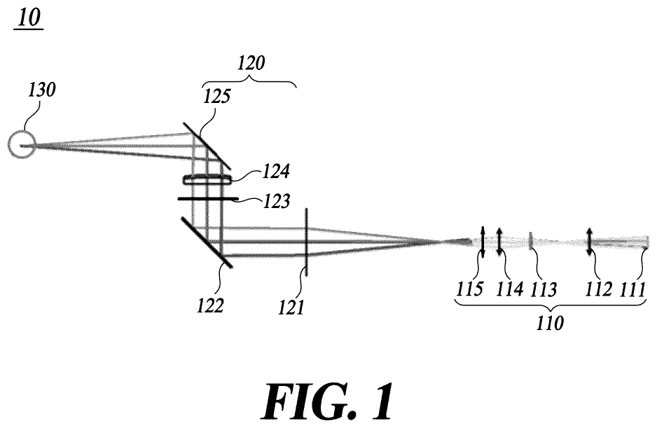

FIG. 1 is an optical structural diagram for describing an optical system for expanding an eyebox in a holographic head-up display, according to an embodiment of the disclosure.

Referring to FIG. 1, an optical system 10 for expanding an eyebox includes all or some of a hologram projection device 110, a wind shield unit 120, and the like. The hologram projection device (110) may combine optical systems of spatial light modulators corresponding to the left and right eyes into one through polarization-multiplexed binocular optics, thereby expanding a field of view by more than twice. The hologram projection device (110) may further apply a polarizing reflection folding optics to secure a propagation distance of a projected intermediate hologram.

The hologram projection device 110 receives a hologram as an input, and generates an intermediate hologram based on a Fourier holography optical structure. Here, the intermediate hologram may be a hologram having a size of 5 inches or more. The hologram projection device 110 may have an optical structure combining polarization-multiplexed binocular optics and polarizing reflection folding optics The hologram received by the hologram projection device 110 as an input may be an actually captured image. Alternatively, the hologram received by the hologram projection device 110 as an input may be generated using a red green blue (RGB) image and depth information extracted from an original image using an artificially generated 3D model. The hologram received by the hologram projection device 110 as an input may be a computer generated hologram (CGH). The depth information may be information related to a distance from the observation point to the object. The RGB image is divided into a plurality of depth layers using the depth information. For example, the RGB image may be divided into five depth layers using the depth information. The RGB image of each layer may be converted into a frequency signal using Fourier transform, and a quadratic phase factor for depth representation for each layer may be convolved to be converted into the hologram.

The hologram projection device 110 includes all or some of a spatial light modulator 111, a first lens 112, a diffractive optical element 113, a second lens 114, a third lens 115, and the like. The spatial light modulator 111 is an active optical element used to control a phase or amplitude of light, and may have a pixelated structure in which pixels that modulate light are arranged in a two-dimensional form. The spatial light modulator 111 modulates the amplitude or phase of light. The viewing angle may be determined as a spacing of the pixels of the spatial light modulator 111, and may be consistent with a diffraction angle calculated from the spacing of the pixels of the spatial light modulator 111. When the spacing of the pixels of the spatial light modulator 111 becomes smaller, the diffraction angle of the spatial light modulator 111 increases and the viewing angle also increases. The spatial light modulator 111 modulates a phase of an input coherent light wavefront.

The first lens 112 is an inverse transform Fourier lens and may be installed at a position away from the spatial light modulator 111 by a focal length of the first lens 112. The first lens 112 may apply an inverse Fourier transform to convert the CGH from a frequency domain to an image domain, thereby reproducing a holographic image. The 2D beam splitter 113 replicates information of the image domain of the CGH into two dimensions as n×n signal having a uniform energy distribution so that the eyeboxes are arranged or overlapped without vacant spaces. The replicated CGHs are arranged or overlapped one another with the original CGH without vacant spaces. The 2D beam splitter 113 is an optical element used to divide incident light into multiple paths. The 2D beam splitter 113 may include a holographic optical element, the diffractive optical element, and a meta-optical element. The position of the 2D beam splitter 113 may be at the position of the image domain reconstructed by the first lens or in front of fourth lens 124.

The second lens 114 is a Fourier lens and may be installed at a position away from the 2D beam splitter 113 by a focal length of the second lens 114. The second lens 114 makes it possible to Fourier transform light waves that are arranged or overlapped without vacant spaces. The size and pixel spacing of the spatial light modulator 111 may be reduced or enlarged by the first lens 112 and the second lens 114. Accordingly, the diffraction angle of the spatial light modulator 111 may increase or decrease, and the viewing angle of the disclosure may be adjustable to about 10 degrees to 20 degrees. The third lens 115 is an inverse transform Fourier lens and may have a focal length of 200 mm to 500 mm. The third lens 115 applies an inverse Fourier transform to hologram signals of the overlapped frequency components that are arranged or overlapped without vacant spaces, and magnifies and projects the overlapped CGHs into a specific space.

The wind shield unit 120 includes all or some of a circular polarizer 121, a 50:50 beam splitter (not shown), a steering mirror 122, a quarter wave plate 123, a reflective linear polarizer (not shown), a fourth lens 124, a windshield 125, and the like. The circular polarizer 121 is an optical element that allows only circularly polarized light to pass through. The 50:50 beam splitter is an optical element that transmits or reflects about 50% of incident light. The steering mirror 122 is an optical component that reflects light and changes a propagation angle of the light. The quarter wave plate 123 is an optical element that delays light to change its polarization direction. The reflective linear polarizer is an optical element that transmits or reflects linearly polarized light. The fourth lens 124 is a lens for compensating curvature and aberration of the windshield 125, and is compensatorily designed in the form of a free curve. The windshield 125 may be glass having a radius of curvature of the actual vehicle. The wind shield unit 120 increases the optical path by repeatedly reflecting or transmitting the light using the circular polarizer 121, the 50:50 beam splitter, the steering mirror 122, the quarter wave plate 123, and the reflective linear polarizer. The wind shield unit 120 may deliver a holographic image to a pupil 130 of a user by forming an eyebox at a position spaced a predetermined distance from the windshield 125 using the overlapped CGHs. Here, the user may be a driver or a passenger of the vehicle. The eyebox may be expanded by the overlapped CGH being delivered to the pupil 130 of the user. Here, the eyebox may be a monocular or binocular eyebox.

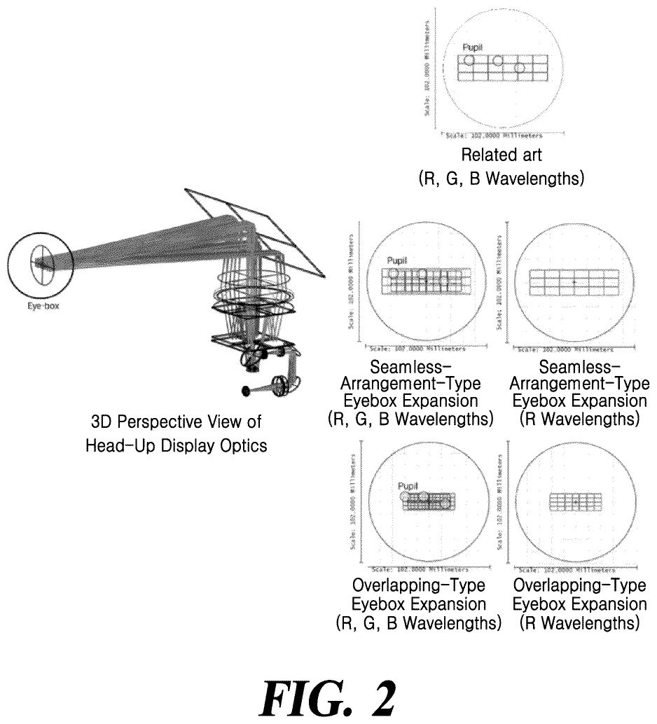

FIG. 2 is a diagram for describing a conventional method of expanding an eyebox and a perspective view of a holographic head-up display and a position of an eyebox and a method of expanding the eyebox according to an embodiment of the disclosure.

Referring to FIG. 2, a conventional method for expanding an eyebox is a method of expanding the eyebox by replicating a CGH using a reflective replication mirror or a refractive optical element without sampling, and combining the CGHs without overlapping region. An original CGH is projected at a (0, 0) position of an expanded eyebox, and the replicated CGHs are projected at other position. In this case, since there is no correlation between pixels at the boundary of each CGH, image quality degradation due to double images may occur at the boundary point of replicated CGHs. In addition, when the CGH is formed at a depth different from the position of the 2D beam splitter 113, the signal propagates further by a specific distance and then divides again into n×n signal, so that image quality degradation due to double images may occur severely.

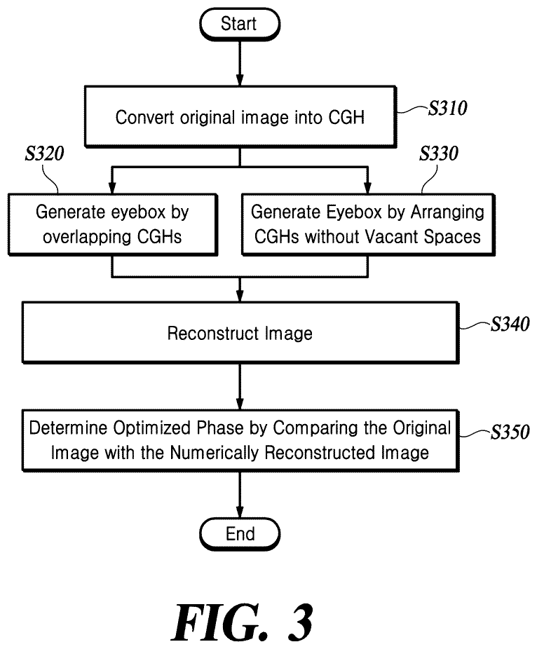

The method for expanding the eyebox according to the disclosure is a method of expanding an eyebox by replicating CGHs and combining the CGHs so that each CGH overlaps by a certain region. In this case, since correlation between pixels occurs in an overlapped region of each CGH, image quality degradation may not occur by deriving an optimal phase value. However, in this case, since some pixels located in an outer region of the expanded eyebox may deviate from the diffraction angle of the spatial light modulator 111, it is necessary to determine an optimized phase to be modulated by the spatial light modulator 111 in consideration of the position of the pupil in the eyebox. Hereinafter, a method for determining the optimized phase to be modulated by the spatial light modulator 111 will be described with reference to FIG. 3.

FIG. 3 is a flowchart for describing a process of determining an optimal phase to be modulated by a spatial light modulator in an expansion of an array-type eyebox or an overlapped eyebox without vacant spaces, according to an embodiment of the disclosure.

Referring to FIG. 3, the original image RGB-D is converted into a CGH (S310). The original image may be converted into the CGH using a color image and the depth information extracted from the original image. Here, a transfer function may be used. The optical system 10 for expanding the eyebox replicates the CGH and overlaps the original CGH and the replicated CGHs to generate the expanded eyebox (S320). The optical system 10 generates the expanded eyebox by using the 2D beam splitter 113 to arrange the CGHs without vacant spaces (S330). Here, a ratio of the region where the CGHs are arranged without vacant spaces or overlapped and a number of CGHs to be replicated may be determined based on the diffraction angle and a designed diffraction order of the 2D beam splitter 113. For example, the overlap ratio may be 50%, and the number of CGHs to be replicated may be eight. In this case, a total of nine CGHs may be overlapped within the eyebox.

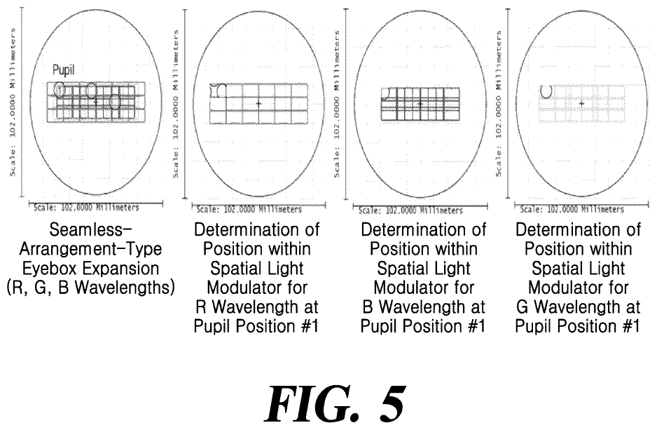

The optical system 10 for expanding the eyebox restores an image by using the expanded eyebox arranged without vacant spaces (S340). Here, a diameter and a size of a pupil may be tracked by an external imaging device mounted outside the system within the expanded eyebox. A holographic image may be numerically reconstructed by inputting the CGH while specifying pixels for each wavelength of the spatial light modulator corresponding to the position of the pupil. A specific method for specifying the pixels for each wavelength is described in FIG. 5.

At this time, effective pixels for each wavelength of the spatial light modulator corresponding to the size and position of the pupil may be obtained from a look-up table. A holographic image that is robust to movements of the pupil within the expanded eyebox may be reproduced by using the effective pixels for each wavelength of the spatial light modulator.

In addition, the optical system 10 for expanding the eyebox reconstructs an image using the overlapped and expanded eyebox (S340). Here, since the pupil may freely move horizontally within the overlapped and expanded eyebox, a plurality of holographic images may be numerically reconstructed assuming that the pupil is located at a specific position within the eyebox.

In the above two types of eyebox expansion methods, a size of the pupil may have a diameter of 2 mm to 8 mm. The optimized phase is determined by comparing a numerically reconstructed image with the original image and by iteratively updating the phase to minimize a loss function (S350). In this case, to solve an image improvement and multiple hologram reconstruction problem, the optimized phase may be determined using stochastic gradient desecent (SGD). The stochastic gradient descent is a progressive learning algorithm for finding a point where loss is minimized. Here, the loss may be a mean squared error (MSE) loss or an SSIM (Structural Similarity Index Measure) loss.

Describing a method for determining an optimal phase, when hologram information of effective pixels for each wavelength of the spatial light modulator corresponding to the size and position of the pupil in the CGHs arranged or overlapped without vacant spaces is reconstructed into one or more holographic images, the loss may be calculated by comparing the reconstructed image with the original image, and the optimized phase in which the loss is minimized may be determined.

For example, in an expanded eyebox arranged without vacant spaces, effective pixels for each wavelength of the spatial light modulator may be specified according to an arbitrary size and position of the pupil, and the captured holographic image and the original image may be iteratively updated through comparison.

In contrast, in an overlapped and expanded eyebox, the optimized phase may be determined by comparing and iteratively updating the captured holographic image and the original image without specifying the effective pixels for each wavelength of the spatial light modulator according to the arbitrary size and position of the pupil.

The optimized phase is input to the spatial light modulator 111, and the 2D beam splitter 113 replicates the light waves modulated by the spatial light modulator 111 and arranges or overlaps them without vacant spaces, so that the user may observe a uniform high-quality holographic image across an entire region of the expanded eyebox.

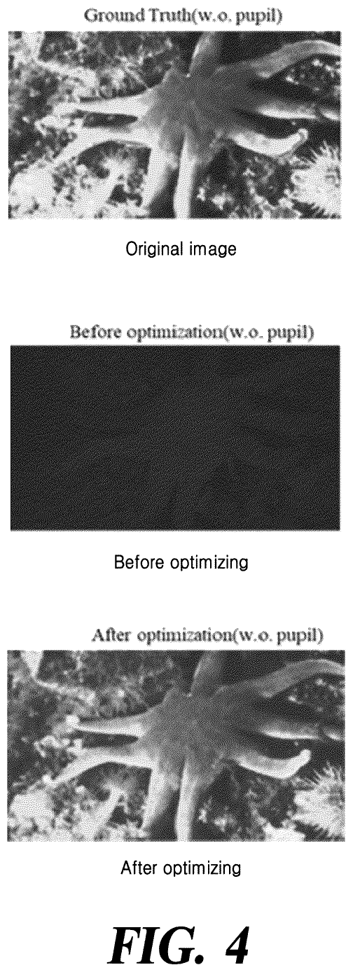

FIG. 4 is a diagram for describing an original image, a reconstructed image before optimizing phase, and a reconstructed image after optimizing phase in an overlapped eyebox, according to an embodiment of the disclosure.

Referring to FIG. 4, an image at the top is the original image. An image in the middle is an image observed in the eyebox generated by arranging or overlapping the replicated CGHs without vacant spaces before optimizing the phase. An image at the bottom is an image observed in the eyebox generated by arranging or overlapping the replicated CGHs after optimizing the phase.

In the image observed in the eyebox generated by arranging or overlapping the replicated CGHs without vacant spaces before optimizing the phase, it is confirmed that a double image phenomenon occurs. In the image observed in the eyebox generated by arranging or overlapping the replicated CGHs without vacant spaces after optimizing the phase, it is confirmed that no image blur or the double image phenomenon occurs and the image is nearly identical to the original image.

FIG. 5 is a diagram for describing a method of specifying an effective region within a spatial light modulator for each wavelength according to a pupil position when an eyebox is expanded by arranging computer-generated holograms (CGHs) without vacant spaces, according to an embodiment of the disclosure.

Referring to FIG. 5, In a method of expanding the eyebox by arranging the replicated CGHs without vacant spaces, eyeboxes are formed at different positions due to differences in diffraction angles caused by wavelength differences among red, green, and blue light sources that pass through the 2D beam splitter 113. When the eyeboxes are overlapped based on the red wavelength, the eyeboxes of the green and blue wavelengths, which have relatively shorter wavelengths, are partially overlapped. By specifying effective pixels of the spatial light modulator for each wavelength according to the size and position of the pupil, the amount of computation can be reduced and the problem of double images caused by adjacent eyeboxes can be resolved.

In contrast, in the case of the eyebox expanded by overlapping the replicated CGHs, the same effective pixels may be repeatedly located at the same position depending on the size and position of the pupil. Therefore, the specification of effective pixels, as presented in the method of expanding the eyebox by arranging the replicated CGHs without vacant spaces, is not effective. Accordingly, an optimized phase may be determined by optimizing correlation among overlapped pixels through direct comparison (S350) between a holographic image captured at an arbitrary position and an original image.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

1. An optical system comprising:
a hologram projection device configured to replicate a computer generated hologram (CGH) and to arrange or overlap a plurality of replicated CGHs without vacant spaces to generate a holographic image; and
a wind shield unit configured to increase an optical path and to reconstruct the holographic image on an eyebox to deliver a reconstructed image to a user,
wherein the hologram projection device comprises:
a spatial light modulator configured to modulate an optical phase based on a phase value of the CGH; and
a 2D beam splitter configured to replicate the CGH based on the phase value to generate the plurality of CGHs,
wherein the phase value is a phase determined based on modulation characteristics of the spatial light modulator.

2. The optical system of claim 1, wherein
a number of the plurality of CGHs is determined based on a diffraction angle of the 2D beam splitter and a designed diffraction order.

3. The optical system of claim 1, wherein
a ratio of the regions where the plurality of CGHs are arranged or overlapped without vacant spaces is determined based on a diffraction angle of the 2D beam splitter and a designed diffraction order.

4. The optical system of claim 1, wherein
the 2D beam splitter comprises a diffractive optical element, a holographic optical element, and a meta-optical element.

5. The optical system of claim 1, wherein
the CGH is converted from an original image.

6. The optical system of claim 5, wherein
when the reconstructed image is reconstructed into a single image or a plurality of images based on a position of a pupil of the user, the phase value is determined by comparing or updating the single image or the plurality of images with the original image, and
the phase value is a phase value at which a loss value between the original image and the single image or the plurality of images is minimized.

7. The optical system of claim 1, wherein
the hologram projection device has an optical structure combining polarization-multiplexed binocular optics and polarizing reflection folding optics.

8. The optical system of claim 1, wherein
a viewing angle of the user is equal to a diffraction angle of the spatial light modulator.

9. The optical system of claim 1, wherein
a viewing angle of the user is determined based on a spacing between pixels of the spatial light modulator.

10. A method performed by an optical system for expanding an eyebox, the method comprising:
modulating an optical phase based on a phase value of CGH using a spatial light modulator;
replicating the CGH based on the phase value using a 2D beam splitter to generate a plurality of CGHs;
arranging or overlapping the plurality of CGHs without vacant spaces to generate a holographic image; and
reconstructing the holographic image on the eyebox to generate a reconstructed image,
wherein the phase value is a phase value determined based on modulation characteristics of the spatial light modulator.

11. The method of claim 10, wherein
the number of the plurality of CGHs is determined based on a diffraction angle of the 2D beam splitter and a designed diffraction order.

12. The method of claim 10, wherein
a ratio of the regions where the plurality of CGHs are arranged or overlapped without vacant spaces is determined based on a diffraction angle of the 2D beam splitter and a designed diffraction order.

13. The method of claim 10, wherein
the 2D beam splitter comprises a diffractive optical element, a holographic optical element, and a meta-optical element.

14. The method of claim 10, wherein
the CGH is converted from an original image.

15. The method of claim 14, wherein
when the reconstructed image is reconstructed into a single image or a plurality of images based on a position of a pupil of a user, the phase value is determined by comparing or updating the single image or an image obtained by averaging the plurality of images with the original image, and
the phase value is a phase value at which a loss value between the original image and the single image or the plurality of images is minimized.

16. The method of claim 10, wherein
a viewing angle of the user is equal to a diffraction angle of the spatial light modulator.

17. The method of claim 10, wherein
a viewing angle of the user is determined based on a spacing between pixels of the spatial light modulator.

18. A computer-readable recording medium having instructions stored thereon that, when executed by a computer, cause the computer to perform the processes of:
modulating an optical phase based on a phase value of CGH using a spatial light modulator;
replicating the CGH based on the phase value using a 2D beam splitter to generate a plurality of CGHs;
arranging or overlapping the plurality of CGHs without vacant spaces to generate a holographic image; and
reconstructing the holographic image on an eyebox,
wherein the phase value is a phase value determined based on modulation characteristics of the spatial light modulator.
